(19) United States
(12) Patent Application Publication
(10) Pub. No.: US 2019/0122232 A1
(43) Pub. Date: Apr. 25, 2019

(54) SYSTEMS AND METHODS FOR IMPROVING CLASSIFIER ACCURACY

(71) Applicant: Mashwork Inc. DBA Canvs, New York, NY (US)

(72) Inventors: Arianna Leidi, New York, NY (US); Robert Simione, II, New York, NY (US); Nicholas DeStefano, Hoboken, NJ (US); Jared Feldman, New York, NY (US)

(21) Appl. No.: 16/171,347

(22) Filed: Oct. 25, 2018

Related U.S. Application Data
(60) Provisional application No. 62/577,021, filed on Oct. 25, 2017.

(51) Int. Cl. G06Q 30/02; G06F 17/30; G06N 99/00; G06Q 50/00

(52) U.S. Cl. CPC G06Q 30/0201; G06Q 50/01; G06N 99/005; G06F 17/30598

(57) ABSTRACT

Certain example embodiments relate to techniques for improving the effectiveness of a classifier. In one example, the classifier may be used to classify user reactions to an event such as, for example, a social media posting. The proposed techniques for improving the effectives of the classifier, in one example, automatically communicates with a verification platform to verify whether already classified user reactions are correctly classified, and when an incorrectly classified user reaction is detected, to determine an optimal negative indicator to be added to a list of negative indicators that is used by the classifier.

### CROSS REFERENCE TO RELATED APPLICATIONS

This application claims the benefit of priority from U.S. Provisional Application No. 62/577,021 filed Oct. 25, 2017, the entire content of which is incorporated herein by reference.

### TECHNICAL FIELD

Certain example embodiments described herein relate to classifiers, and more particularly to improving the accuracy of classifiers, and even more particularly to improving the efficiency of binary classifiers.

### BACKGROUND

Text classification has been performed for a long time, and in many applications. With the pervasive use of social media systems becoming the norm throughout society, the vast amounts of comments and the like made by social media users in response to various events offer another information-rich source for text classification.

Entities such as corporations and individuals use social media platforms (e.g., Facebook®, Twitter®, Youtube®, blogs, Snapchat®, Instagram® and the like) to engage in conversations and to convey their views to their respective audiences. Companies extensively use social media platforms, such as those mentioned above, to advertise products and services, to convey their views on certain social and other issues, etc. In the various social media systems, an initial post of some particular content by a user or company often causes other users accessing that content to react by posting one or more comments associated with the initial post. Considering Facebook® as an example social media platform, the idea is that each “post” elicits certain emotion reactions from users, where the nature of such emotion reactions would in turn lead the user to share/like the post. The downstream consequence of sharing/liking a post is that the post would be spread to other users, who would then share/like the post etc., thereby increasing reach. The reactions of users to the various posts made to social media platforms by a corporation can yield information of high value. For example, it enables understanding what types of posts (in terms of certain emotion categories) would lead to more/less sharing/liking behavior.

Some of the present inventors previously created what is believed to be the first language analytics software platform that can inform users about how their audience feel about content at scale. U.S. Pat. No. 9,430,738, issued on Aug. 30, 2016, which is herein incorporated in its entirety, describes a language analytics platform for automatically categorizing and summarizing emotions expressed in social chatter by using a “knowledge base” of emotion words/phrases as an input to define a distance metric between conversations and conducting hierarchical clustering based on the distance metric. Canvs®, of New York, N.Y., offers a service utilizing technology similar to that described in U.S. Pat. No. 9,430,738, that can, among other things, report on the emotional reaction generated by television episodes. Another patent application by some of the inventors, U.S. application Ser. No. 15/695,622, described emotion categories that are defined based upon groups of emotion tokens, and the quantification of, for each social media content record (e.g., Facebook® post) and/or group of social media content records (e.g., Facebook® page), a relationship between one or more key performance metrics (engagement metrics) and one or more emotion categories. The identified relationships can then be used to measurably improve the effectiveness of social media content of an entity.

The continuing growth of accessibility to the Internet throughout the world, and the continued growth in both the number of people using mobile devices to access the Internet and the frequency with which people use mobile devices and the like to access the Internet are driving an explosive growth in the level of engagement an entity's audience has with that entity's social media presence. Corporations and other entities now compete for “eyeballs” on their social media presence. As the manner in which audiences consume advertising and other information shifts away from conventional avenues such as radio, television, newspapers and other print media, to social media platforms, it becomes more important that corporations and other entities have effective techniques by which to efficiently and accurately determine the level of user engagement associated with its social media presence. Thus, improved techniques for classifying user reactions to events expressed in some textual form are desired.

### SUMMARY OF EXAMPLE EMBODIMENTS OF THE INVENTION

Certain example embodiments described herein relate to techniques for improving the accuracy and/or efficiency of a classifier such as, but not limited to, a classifier that classifies user reactions in social media and the like according to emotions. The classifier is improved in embodiments, for example, by continually updating a database of non-emotion tokens.

According to an embodiment, a system for determining effectiveness of content posted on a social media network is provided. The system is configured to perform operations comprising: receiving a set of social media content records posted to a network location and, for each social media content record in the set, one or more associated user reaction records posted in response to the social media content record; assigning one or more emotion tokens to respective user reaction records based at least on an absence of any non-emotion tokens from a collection of non-emotion tokens in the respective user reaction records; generating emotion engagement metrics for respective ones of the social media content records based on the emotion tokens assigned to the user reaction records associated with the respective social media content records; outputting information associated with the generated emotion engagement metrics; and taking as input respective ones of said user reaction records to which one or more emotion tokens are assigned, performing processing to determine non-emotion tokens and adding the determined non-emotion tokens to the collection of non-emotion tokens, wherein the processing to determine non-emotion tokens includes electronically obtaining evaluations from a crowdsourced evaluation platform for a plurality of pairs of a user reaction record and an emotion token assigned by said assigning to the user reaction record.

According to another embodiment, a method is provided. The method comprises: receiving as input, user reaction records to which one or more positive indicator tokens are assigned; performing, using the received input, processing to determine negative indicator tokens; and adding the determined negative indicator tokens to a collection of negative indicator tokens, wherein the collection is utilized by a computer process for assigning positive indicator tokens to user reaction records.

According to another embodiment a non-transitory computer readable storage medium having stored thereon instructions is provided. The stored instructions, when executed by a processor of a computer, cause the computer to perform operations comprising: receiving as input, user reaction records to which one or more positive indicator tokens are assigned; performing, using the received input, processing to determine negative indicator tokens; and adding the determined negative indicator tokens to a collection of negative indicator tokens, wherein the collection is utilized by a computer process for assigning positive indicator tokens to user reaction records.

These aspects, features, and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a block diagram of a system for monitoring events (e.g. social media postings) and associated user reactions (e.g. user postings/comments in response to the social media posting) by classifying the user reactions into various categories (e.g. emotions), where the system also includes a subsystem for improving accuracy and/or efficiency of the classifier, according to some example embodiments;

FIG. 2 is a flowchart for a process to monitor events and corresponding user reactions in a system such as the system shown in FIG. 1 according to some example embodiments, where the output of the monitoring may be provided, for example, to a system predicting the effectiveness of social media content;

FIG. 3 is a flowchart of a process for improving the accuracy and/or efficiency of a classifier, such as, for example, the classifier of FIGS. 1 and 2, according to some example embodiments;

FIG. 4 is a flowchart of a process for determining, by querying a verification platform, whether a classification of a user reaction record is accurate, in accordance with some example embodiments;

FIG. 5 is a flowchart of a process that adds a new negative indicator (e.g. non-emotion token) to a database of negative indicators (e.g. database of non-emotion tokens), in accordance with certain example embodiments; and

FIG. 6 is a block diagram of an example computer platform which may be used in an implementation of the system shown in FIG. 1.

### DETAILED DESCRIPTION OF EXAMPLE EMBODIMENTS

As described above, systems that provide emotional analysis of comments and other user reactions in social media about posted and/or displayed content and other events play an increasingly important role. With the increase in the volume of user comments and the number and diversity of social media avenues that can generate such comments, the techniques provided by example embodiments to improve accuracy in classifying texts and other user reactions with the correct emotion would be important for the effectiveness of such systems.

In the description below, the term “event” may be used to refer to any type of social media posting or other event notification which may lead to specific reactions from users of the system. The term “user reaction record” may be used to encompass all types of user responses that are (or is translated to) text. Some example embodiments automatically identify a user reaction record that has been incorrectly classified (e.g. record being assigned to an incorrect emotion) and within the user reaction record finds non-emotions, which are sequences of words that in their most common uses do not carry the emotion to which the user reaction record is currently classified into. In some example embodiments, the finding of non-emotions is performed by querying an external verification platform to determine whether the emotion classification of the user reaction is correct.

Some example embodiments provide a novel way of interacting with a verification platform. The verification platform may be a fully-automated platform (e.g. a platform based on machine learning automatically receiving and responding to the query) or a partially-automated platform such as a crowdsourcing platform where the platform provides automated interaction with one or more humans that can answer certain queries. In an example embodiment, the Amazon MTurk® is used as the verification platform. It is believed that the proposed embodiments provide a novel use of crowdsourcing, since the way crowdsourcing platforms such as MTurk® are used in conventional techniques is to test assumptions and gather statistics that are then manually checked by humans. In contrast to conventional techniques, example embodiments send a first batch of already classified user reaction records sampled from a database to the verification platform in order to identify the incorrectly classified user reaction records in the sample. Thereafter, the example embodiments send other user reaction records that contain sequences of words that were contained in the identified incorrectly classified user reaction records, thereby identifying which sequences carry that emotion and which ones don't. This process consists of multiple automatic iterations, each of which depends on the result of previous iterations, and learns valuable information that can then automatically be used in the system's text processing for classifying user interactions and the like according to emotion.

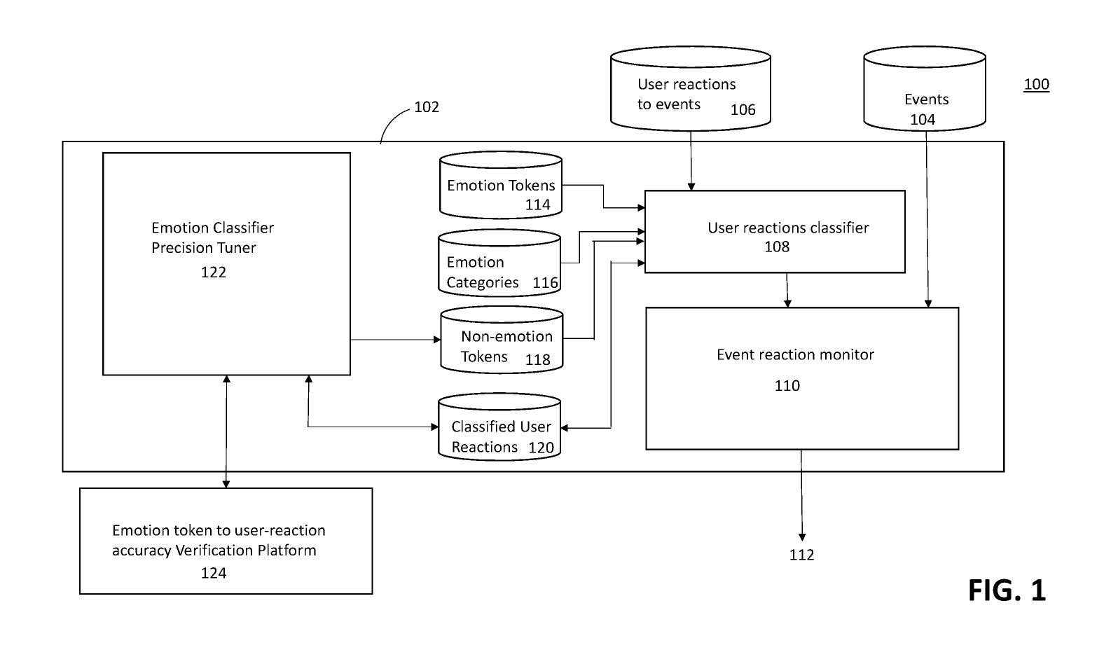

FIG. 1 is a block diagram of a system 100 for user reaction monitoring, according to some embodiments. The system 100 is configured with the additional capability to continuously improve the accuracy and/or efficiency with which it classifies user reaction records. As described above, user reaction records may comprise comments, feedback and the like that users provide in response to viewing an event such as a posting on a social media platform, and the monitoring/tracking of such user reaction may be for purposes such as, for example, improving engagement with a corporation's clientele, directing advertising and other information to users, predicting the effectiveness of social media content, etc.

System 100 includes a computer 102, a source for event records 104 and a source for user reaction records 106, a database of emotion tokens 114, and a database of emotion categories 116, a database of non-emotion tokens 118, and a database of already classified user reactions 120. The computer 102 is configured to process event records and user reaction records in order to determine a relationships between an event and one or more emotional reactions caused by the event. The computer 102 may be further configured to utilize the determination of relationships between monitored events and corresponding user reactions to generate certain metrics regarding such events that are then provided to other systems for use in further analysis or in improvement in advertising or content creation improvements. U.S. patent application Ser. No. 15/695,622 filed on Sep. 5, 2017, the content of which is hereby incorporated by reference in its entirety, described a system in which, in an example implementation, social event postings and corresponding user reactions are analyzed to derive metrics for user engagement, that are then used for purposes such as improving social media posting content and the like.

Embodiments of the present invention also include the capability of continuously improving the accuracy and/or efficiency of the evaluation process by which classifiers classify user reactions to events. For example, whereas, as described in the above incorporated U.S. patent application Ser. No. 15/695,622, computer 102 evaluates events and corresponding user reactions to classify respective user reactions as indicating various emotion categories, the embodiments described in this application provides the capability to continuously improve the accuracy and/or efficiency of the evaluation process by which the computer determines whether respective user reactions indicate a particular emotion.

In some example embodiments, the computer may include a user reaction classifier 108 which is configured to receive records of user reactions to events (e.g. user reaction records), to determine whether each record indicates an emotion, and to classify each record by assigning one or more tokens (e.g. emotion token and/or emotion category token) indicating the particular emotion represented in the user reaction. The user reaction classifier 108 may receive user reaction records to be classified from a user reaction record source 106, and may also interact with a database of emotion tokens 114 and/or a database of emotion categories 116 to obtain classification information. The user reaction classifier 108 may also receive classification information from a database of non-emotion tokens 118. In an example classification process, user reactions classifier may classify a user reaction record as corresponding to a particular emotion and/or emotion category if it detects that the user reaction record includes one or more emotion tokens that are considered to represent the particular emotion, and that the user reaction record does not include any non-emotion indicators such as those represented by the non-emotion tokens database 118. The user reaction record with its classification may then be saved in a classified user reactions database 120. The classification output from the user reactions classifier 108 may also be provided to an event reaction monitor 110.

The event reaction monitor 110 may, based on classification input received from the user reactions classifier 108 and event information received from event source 104, determine various metrics, such as, for example and without limitation, engagement metrics and the like, and provide such metrics to another system 112 which may use the output information in improving event content and the like. The user reaction classifier 108 and the event reaction monitor 110 may be implemented in some embodiments by process 200 described below.

In example embodiments of the present invention, an emotion classifier precision tuner 122 operates to improve the classification performed by the user reactions classifier 108. In particular, in the particular embodiments described in relation to FIG. 1, the emotion classifier precision tuner 122 operates to add new non-emotion tokens to non-emotion token database 118. By enhancing the non-emotion tokens that are available for the classifier 108 to utilize, the accuracy of the classifier is improved (e.g., the false positive classifications may decrease). By ensuring that that, for a particular type of non-emotion indication, a shortest non-emotion token is identified and provided to the non-emotion token database 118, the emotion classifier precision tuner 122 may also improve the efficiency of the classification process (e.g. by using the most general token indicative of a non-emotion, the number of non-emotion tokens directed to a particular non-emotion is reduced).

The emotion classifier precision tuner 122 interacts with a verification platform 124 to verify the accuracy of certain classifications. For example, the emotion classifier precision tuner 122 may user verification platform 124 to verify the accuracy of the classifications of respective user reaction records in the classified user reactions database 120. The emotion classifier precision tuner 122 may be implemented by the 300, 400 and 500 described below.

The verification platform 124 operates to receive queries from the motion classifier precision tuner 122 and to respond to each individual query. A query may include a user reaction record, or information based on a user reaction record, and the associated emotion token or emotion information based on the associated emotion token. The verification platform 122 operates to determine the correctness of the association between the user reaction record and the emotion token, and may respond whether a binary yes or no indicating whether the association is correct or incorrect. In some cases, the query may consist of any substring (e.g., not necessarily a user reaction record) and an associated emotion token, and the response from the verification platform 124 may either be a “yes” indicating that the substring does correspond to the emotion represented by emotion token, or a “no” indicating that the substring does not correspond to the emotion represented by the emotion token. In some embodiments, the verification platform 122 is a crowdsourced platform such as Mturk®. In some other embodiments, the verification platform is an entirely automated platform.

The source of social media content records and user reactions (e.g., events source 104 and user reactions to events store source 106) may be one or more databases of social media content records, social media content accessed in real time, or a combination of both. Examples of social media content records include Facebook® posts, Twitter® posts, Youtube® videos, blog postings, LinkedIn® postings, Instagram® postings and the like. The user reactions may be the responses other users post in response to the social media content records. That is, the sources 106 and 104 may include, in some example embodiments, a Facebook® post made by a first user, and one or more comments posted by other users in response to that Facebook® post. In some embodiments, social media content records and corresponding user reactions can be obtained by accessing an application programming interface (API) provided by the social media platform/server. Sources 104 and/or 106 may also provide engagement metric statistics associated with the events of source 104. Engagement metrics represent measurements of user reactions to social media content records. Example engagement metrics may include number of “likes” (e.g., of Facebook® posts, blog posts, Youtube® posts etc.), number of “retweets”, etc.

The database of emotion tokens 114 is a collection of words that are used to represent the emotions experienced by users when they access social media content. Emotion tokens may include words or phrases, and the collection of emotion tokens may include tokens that are automatically determined and/or input by operators. According to some example embodiments, the emotion token database 114 may be formed as described in U.S. Pat. No. 9,430,978 which is incorporated by reference. The database 114 may be continually grown and improved based upon actual social media posting and user reactions in order to ensure that a most current view of any trends in language use in social media platforms is captured. Automatic analysis and word extraction and/or manual techniques may be used in growing the database 114. The database may be configured to grow on a regular (e.g., daily basis) or continuously. In some embodiments, a team of human coders may go through a sample of tweets daily, and add any new emotional tokens that are not already in our token dataset. In some embodiments, an automated program using rules and heuristics may perform this task on a daily basis or on a continuous basis. In some example embodiments, the database 114 is continually updated using unsupervised learning techniques in an entirely automated manner.

The database of emotion categories 116 is a collection of emotion categories. An emotion category represents a type of emotion experienced by a user accessing a social media content. The system determines emotion categories by categorizing the emotion tokens into distinct categories. The categorizing may be fully automated, for example, using an unsupervised learning technique, or may be assisted by an operator. Each emotion category may be described by at least one of the tokens in the emotion token database 114. Some emotion categories may each be described by two or more of the emotion tokens.

The database of non-emotion tokens 118 includes words and sequences of words (e.g. tokens) that are recognized, if they exist in a particular user reaction, as indicating that the particular reaction does not convey an emotion. In example embodiments, if a system recognizes that a particular user reaction record which is already classified or is tentatively classified as conveying an emotion does indeed contain any one or more of the non-emotion tokens, that particular user reaction record is regarded as not conveying an emotion. Similar to the emotion tokens database 114, non-emotion token database 118 too may be continually grown and improved based upon actual social media posting and user reactions in order to ensure that a most current view of any trends in language use in social media platforms is captured. Indeed, as would be clear in the descriptions of the embodiments, the automated growing and enhancement of the non-emotion token database as provided in example embodiments ensures that the non-emotion token database too grows with any changes that occur in the language usage etc., of users whose reactions are captured by the system.

The database of classified user reactions 120 stores user reaction records and corresponding emotion assignments. The emotion assignments may include one or more emotion tokens and/or one or more emotion categories.

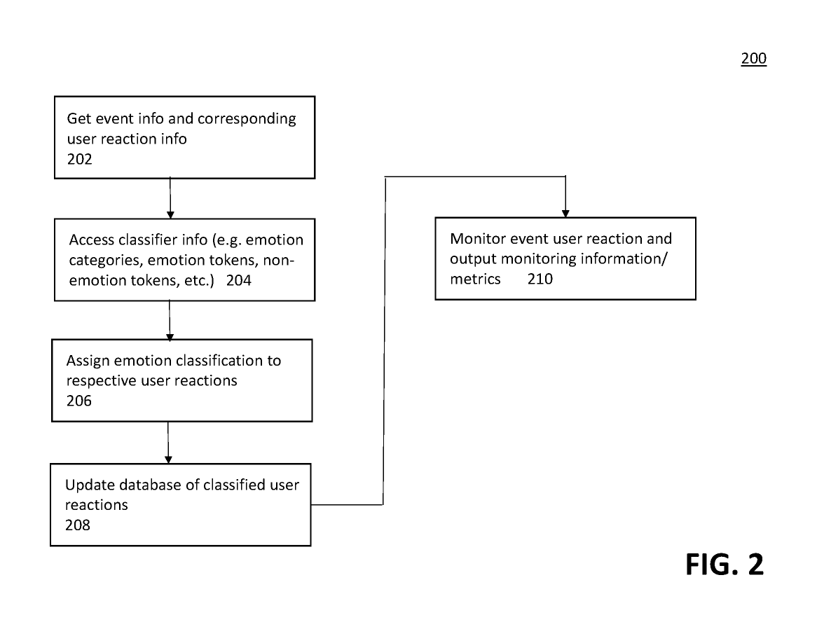

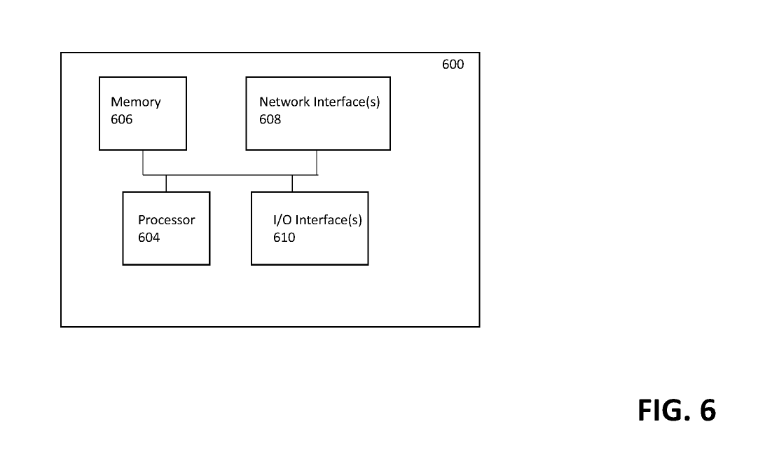

According to some embodiments, the computer 102 may perform the processes described in relation to FIGS. 2-5 below. FIG. 6 illustrates a block diagram for a computer such as computer 102.

FIG. 2 illustrates a flowchart for a process 200 to monitor events and corresponding user reactions in a system such as the system shown in FIG. 1 according to some example embodiments, where the output of the monitoring may be provided, for example, to a system predicting the effectiveness of social media content. In some embodiments, the process 200 may be performed by the user reaction classifier 108 and the event reaction monitor 104. Although process 200 includes operations 202-210, in some example embodiments, 202-210 may be performed in an order different from that shown, or may be performed with one or more additional operations or without one or more operations 202-210.

After entering process 200, at operation 202, event information and corresponding user reaction information are received. For example, event information may be received from an event source 104, and user reaction information may be received from user reaction record source 106. According to some embodiments, events and user reaction records may be, for example, to respective social media posts and corresponding user responses submitted in relation to such posts, respectively. For example, at this operation in some example embodiments all the posts on one or more specified Facebook® page and corresponding posted user reactions/comments may be obtained. According to some embodiments, the events source 104 and user reaction record source 106 may be services external to computer 102. In some embodiments, such events and corresponding user reaction records may have been previously received and stored within a data storage that is in the control of computer 102. In some embodiments, the social media content records and user reactions are obtained in response to a user input received via a network, and in other embodiments, the same is obtained in real-time being pushed to computer 102 by an external source.

At operation 204, process 200 access classifier configuration information. For example, as described above, in some embodiments classification of a user record may include detecting whether any of a plurality of emotion tokens exist within the user reaction record, and whether none of a plurality of non-emotion tokens exists within the same user reaction record. Thus, process 200 may access the emotion tokens database 114, emotion categories database 116 and non-emotion tokens database 118 to obtain information required for the classification.

At operation 206, the classification is performed. For example, emotion tokens are associated with each user reaction that was obtained at operation 202. The system may extract specific tokens from the obtained user reactions (e.g., post comments) and identifies emotion tokens from the text. Example emotion tokens may include “love”, “hate”, “excited”, “crazy” and like words or phrases that represent emotion (see, for example, FIG. 2 of U.S. application Ser. No. 15/695,622). In example embodiments, the database of emotion tokens 114 from which the system obtains emotion tokens to match against user reactions may be continually growing and/or being modified to include new words and phrases that social media users use to convey emotion. For example, in some embodiments, the database 114 includes more than 4 million distinct tokens and their “alternative” spellings (e.g., luv, loove, looove, loooove are all different misspellings of “love”).

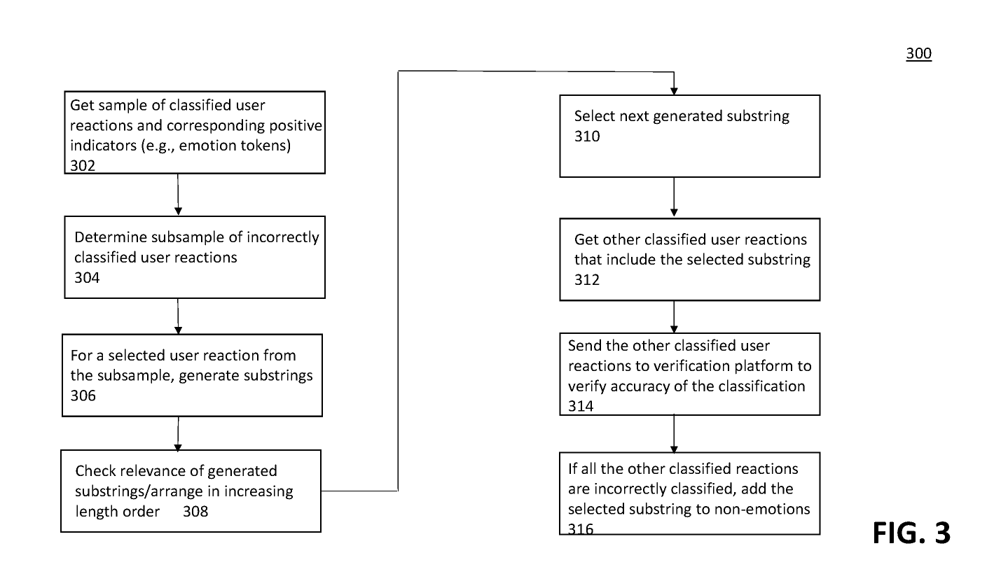

In some embodiments, after extracting emotion tokens from the data, emotion categories are assigned to the user reactions in accordance with the already assigned emotion tokens. According to some embodiments, a database of emotion categories such as database 116 may be accessed to determine the mapping from emotion tokens to emotion categories. FIG. 3 of U.S. application Ser. No. 15/695,622 illustrates a part of a database of emotion categories.

At operation 208, process 200 updates the classified user reactions database 120 by adding the newly assigned pairing of the user reaction record and the emotion token. In some embodiments, an emotion category may also be associated with each entry in the database 120.

At operation 210, monitoring event user reactions and outputting of monitoring information/metrics is performed. The monitoring may be to perform, on an ongoing basis, monitoring of the user sentiment associated with certain web sites, services, social media postings and/or other events. The monitoring may be based, at least, on the classifying of user reaction records as either conveying a certain emotion or not conveying an emotion, and may additionally be based on various engagement metrics such as the number of “likes”, number of “retweets” etc. The output may be to a display, a storage device or to another network location. The output may be used, for example, by a brand manager or other user to improve the Facebook® page by adding, modifying or removing content in order to improve upon the selected engagement metric and identified one or more emotion categories. For example, a brand manager may, upon obtaining the monitoring results, remove or modify some content in that particular Facebook® page to reduce the effect of the “afraid” emotion category and thereby improve the reach of the page. In some example embodiments, the output may be fed into another process. For example, an output specifying the prevalent emotion token may be input to a process which builds or automatically modifies a Facebook® page (or other page displaying a set of social media content records) by adding content previously categorized according to the various emotion categories.

After operation 210, process 200 is complete.

Although the above process is described while primarily using Facebook® as an example, it should be noted that the teachings are applicable to any social media platform including, but not limited to, Twitter®, Youtube®, LinkedIn®, Instagram®, blogs, etc.

FIG. 3 illustrates a flowchart for a process 300 for improving the accuracy of a classifier, such as, for example, the classifier of FIGS. 1 and 2, according to some example embodiments. In an example embodiment, process 300 may be performed by emotion classifier precision tuner 122 in order to improve the classification process performed by the user reactions classifier 108. Although process 300 includes operations 302-316, in some example embodiments, 302-316 may be performed in an order different from that shown, or may be performed with one or more additional operations or without one or more operations 302-316.

After entering process 300, at operation 302 a sample of classified user reaction records and corresponding emotion tokens are obtained. For example, the emotion classifier precision tuner 122 may obtain a plurality of classified user reactions records from database 120. Each classified user reaction record comprises a string representing a user reaction (e.g., a text message etc.) and an emotion token that was associated with the user reaction by the user reaction classifier 108.

At operation 304, a subsample of incorrectly classified user reaction records is determined from the sample obtained at operation 302. The incorrectly classified user reaction records may be identified by submitting requests to a verification platform such as verification platform 124. A process such as process 400 described below can be used to determine a subset of incorrectly classified user reaction records.

At operation 306, one of the incorrectly classified user reaction records is selected from the subsample obtained at operation 304. For the selected incorrectly classified user reaction record, a plurality of substrings is generated. The generated plurality of substrings may be referred to as the set of candidate non-emotion tokens.

In effect, starting by determining that a particular classifier (e.g. a classifier for a particular emotion) was incorrect in classifying a given user reaction positively due to an emotion token it found, the embodiments then proceed to find a phrase contained within the user reaction that also contains the emotion token such that the phrase should be entered into the classifiers list of non-emotion tokens in order to improve the precision of positive classification.

In an example embodiment, starting from the misclassified user reaction and emotion token described at the starting point for the invention, first make a list of all possible phrases in the user reaction record that are candidates to be non-emotion tokens. These are all possible phrases of the user reaction record that include the emotion token but are not equal to the emotion token (so they are always strictly larger than it). For example, suppose the classifier takes the user reaction record “Who said its boring I didnt” that was incorrectly classified positively to the question “does the author feel like something/someone is boring?” because the emotion token “its boring” was found inside the user reaction record. Then the list of candidate non-emotion tokens, ordered from least length to most are: “said its boring”; “its boring I”; “who said its boring”; “said its boring I”; “its boring i didn't”; “who said its boring I”; “said its boring i didn't”; and “who said its boring i didn't”.

At operation 308, optionally, the plurality of substrings (or, as alternately referred to, the set of candidate non-emotion tokens) is processed to filter out any substrings that need not be further processed. For example, if a substring is already present as a token in the non-emotion token database, that substring can be removed from the set of candidate non-emotion tokens. Moreover, if a substring does not appear above a configured threshold number of times in the user reactions data 106 or classified user reaction 120, it may be an indication that the particular substring is not frequently used, and it is therefore not efficient to perform the processing for adding that substring to the database of non-emotion tokens 118.

Also at operation 308, if not already in ordered form, the plurality of candidate non-emotion tokens is arranged in order of the length of the respective substrings.

The processing at operations 310-316 may be performed for each candidate non-emotion token or until a predetermined stop condition is satisfied.

At operation 310, a next generated substring is selected. Because the plurality of candidate non-emotion tokens is arranged in order of substring length, the selected candidate non-emotion token is the shortest substring that is yet not processed by operation 310-316.

At operation 312, other user reaction records that include the selected candidate non-emotion token are obtained. For example, the other user reaction records may be obtained from the classified user reactions records database 120. That is, for each candidate non-emotion tokens, example other user reaction records that represent the historical use of that candidate are found from a historical source of user reaction records such as the classified user reactions database 120.

Given the misclassified user reaction record from operation 306 and the candidate non-emotion token, a set of representative user reaction records are found from a historical source of user reaction records such as the classified user reaction database 120 according to the following.

Suppose a user reaction record consists of the sequence of words W_1, . . . W_i , . . . , W_j, . . . W_n, where W_i, . . . , W_j is the candidate non-emotion token under present consideration. (For completeness, it should be noted that the candidate non-emotion token can start at the beginning or end of the user reaction record, so that W_i may be W_l and W_j may be W_n.) Then the historical source of user reaction records (e.g. classified user reaction record database 120) is queried for all user reaction records that satisfy the following clause: “All texts that contain W_i . . . W_j and do not contain W_i−1, W_i, . . . , W_j, W_j+1”. The second clause of the query excludes W_i−1 from its definition if W_i is at the beginning of the misclassified user reaction record and likewise excludes W_j+1 from its definition if W_j is at the end of the misclassified user reaction record, because in these cases those words would not exist to define the query. The purpose of this exclusion clause is to not accidentally test candidate non-emotion tokens that will be evaluated later on in subsequent steps of the process only if the candidacy of the current candidate non-emotion token is rejected.

As an example, if the misclassified user reaction record is “Who said its boring I didnt” and the candidate non-emotion token at this step is “its boring i” then the query would be to return: “All texts that contain “its boring i” and not “said its boring i didnt””.

Given all the user reaction records returned by the previous query, find all the unique pairs of words (A, B) such that the phrase A, W_i, . . . , W_j, B appears in the user reaction records returned, as well as all unique C and D such that W_i, . . . , W_j, C starts a user reaction record and D, W_i, . . . , W_j end a user reaction record. Another way to say this is to find all pairs (A, B) that fit the template “A, W_i, . . . , W_j, B” in the user reaction records, and the words C and D that fit the template “W_i, . . . , W_j, C” at the beginning of user reaction records and the template “D, W_i, . . . , W_j” at the end of the user reaction record. For each of these unique templates count how many user reaction records returned from the historical source that fit each template.

So each template has a corresponding set of user reaction records that is a subset of the user reaction records returned from the historical source, and the number of user reaction records in the subset of corresponding user reaction records divided by the number of all user reaction records returned from the historical source is the percentage of use of the candidate non-emotion token that the particular template corresponds to. Take the smallest subset of these templates possible such that the corresponding user reaction records of templates in the subset account for more than 50% of the total number of user reaction records from the query results. For each template, select a user reaction record from its corresponding subset to be the representative user reaction record for that template. The collection of the representative user response records for all the templates selected in the previous step become known as the representative user reaction record for the candidate non-emotion token itself. Thus the query step is completed.

At operation 314, the other user reaction records and their classifications are sent for verification by a verification platform. For each candidate non-emotion token, it is considered a possible non-emotion token if the verification platform determines that each of its representative user reactions from the previous step should be classified negatively. Given a candidate non-emotion token, only one of its representative user reaction records needs to be classified positively by the verification platform in order to reject its candidacy as a non-emotion token, so such a response from verification platform stops any more questions about representative user reaction records of that candidate non-emotion token from being asked.

Starting from the candidate non-emotion tokens of least length as in the ordered list, the first candidate non-emotion token to have all of its representative user reaction records classified negatively by the verification platform leads to the completion of the process, since this is then considered a sufficient non-emotion tokens and its length means it is of optimal length.

The embodiments then takes the first candidate non-emotion token to have all of its representative user reaction records classified negatively by the verification platform, and inserts it into the classifier's list of non-emotion tokens.

A process such as process 500 (described below) may be utilized to verify the accuracy of respective other user reaction records.

At operation 316, based on the verification status of the set of other classified user reaction records, it is determined whether or not to add the currently selected candidate non-emotion token to the non-emotion token database. According to some embodiments, if all the user reaction records in the currently obtained set of other classified user reaction records have been processed by the verification platform and have been determined to be incorrectly classified, then the currently selected substring is added to the database of non-emotion tokens 118. If at any point during the processing of the set of other classified user reaction records, any of the other classified user reaction records is determined to have been correctly classified as indicating an emotion, then the currently selected substring is not considered a candidate non-emotion token.

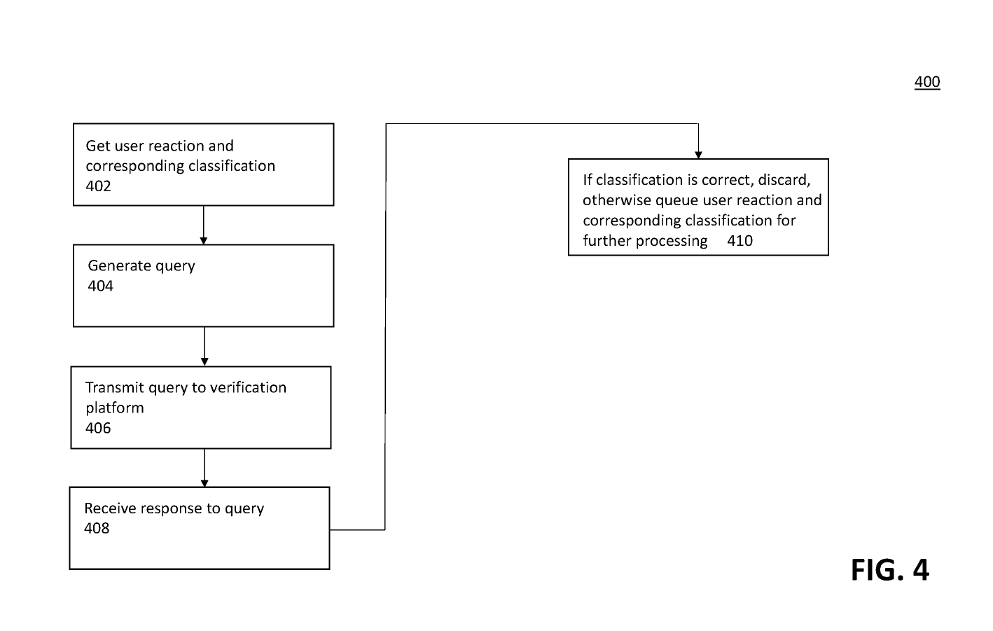

FIG. 4 illustrates a flowchart for a process 400 that may be used in performing operation 304, in some example embodiments. Although process 400 includes operations 402-410, in some example embodiments, 402-410 may be performed in an order different from that shown, or may be performed with one or more additional operations or without one or more operations 402-410.

After entering process 400, at operation 402, one of the user reaction records from the sample obtained in operation 302 is selected. The selected user reaction record has an emotion token already associated with it.

At operation 404, a query is generated. The query may include information based on the user reaction records and information based on the associated emotion token. In some embodiments, the query comprise the entirety of the user reaction record and the associated emotion token.

At operation 406, the generated query is transmitted to the verification platform.

At operation 408, the response to the query is received. The response may include a single response or may include multiple responses. The verification platform is described in relation to verification platform 124. In example embodiments, the verification platform may send the received query to one or more workers (human or computer, depending on the embodiment) to obtain answers to the query. When the same query is sent to more than one worker, the system is taking advantage of the verification platform's capability to have workers with different levels of capabilities as to how they can respond to various queries. By implementing a rule selecting the answer returned by a majority of the workers to be returned to the querying system as the response to the query, the system may take advantage of the verification platform's capabilities to improve the reliability of the system.

At operation 410, if the verification platform has found that the classification of the user reaction record is correctly assigned, then no further processing is performed on that user reaction record. Alternatively, if the verification platform has found that the classification of the user reaction record is incorrect, then that user reaction record is queued for further processing.

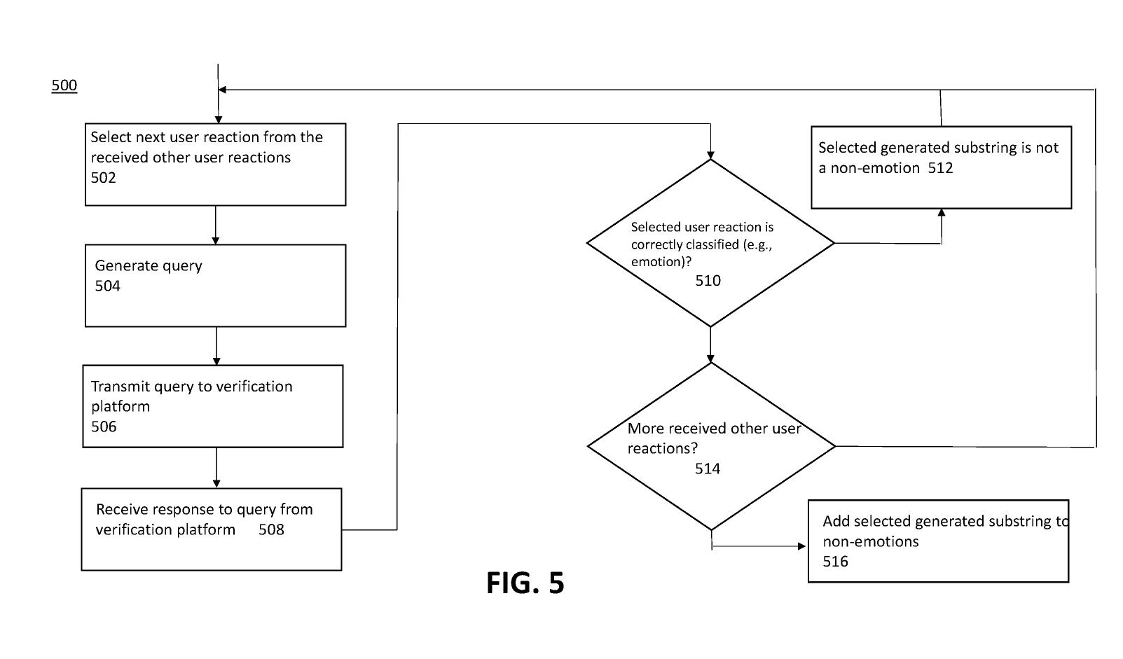

FIG. 5 illustrates a flowchart for a process 500 according to some embodiments. Process 500 may be used, for example, when performing operation 314 and/or 316 described above. Although process 500 includes operations 502-516, in some example embodiments, 502-516 may be performed in an order different from that shown, or may be performed with one or more additional operations or without one or more operations 502-516.

After entering process 500, at operation 502, the next user reaction record is selected from a set of other classified user reaction records such as, for example, the set of other classified user reaction records obtained for a particular candidate non-emotion token at operation 312 described above.

At operation 504, the query to be submitted to the verification platform is generated. The query includes a selected other classified user reaction record and the associated emotion classification.

At operation 506, the query is transmitted to the verification platform.

At operation 508, a response is received from the verification platform. The response may include a single response or may include multiple responses. The verification platform is described in relation to verification platform 124. In example embodiments, the verification platform may send the received query to one or more workers (human or computer, depending on the embodiment) to obtain answers to the query. When the same query is sent to more than one worker, the system is taking advantage of the verification platform's capability to have workers with different levels of capabilities as to how they can respond to various queries. By implementing a rule selecting the answer returned by a majority of the workers to be returned to the querying system as the response to the query, the system may take advantage of the verification platform's capabilities to improve the reliability of the system.

At operation 510, it is determined whether the currently selected user reaction record is correctly classified. This determination is based on the response received from the verification platform.

If the answer to operation 510 is “yes, then at operation 512 it is determined that the currently selected substring (i.e., the substring selected at operation 310 described above) is not a non-emotion.

If the answer to operation 510 is “no”, then at operation 514 it is determined whether more user reaction records in the set of other classified user reaction records are yet to be verified.

If it is determined that more user reaction records are yet to be verified, then process 500 proceeds to selected the next user reaction record at operation 502. Alternatively, if it is determined that all the user reaction records in the set of other user reaction records have been verified, then at operation 516, the currently selected substring is added to the non-emotion token database. By adding non-emotion tokens to the non-emotion tokens in this manner, the system continually improves the accuracy of its classifications and also adapts to changes in the use of language that may occur in the various avenues of social media. Moreover, the efficiency of the system is improved by actively selecting the shortest string as the non-emotion token that is added to the non-emotion token database.

After process 516, process 500 terminates.

FIG. 6 illustrates a computing platform 600 such as that may be utilized by computer 102 to execute processes 200, 300, 400 and 500. According to some embodiments, the computer platform 600 includes a processor 604, a communicating infrastructure 605 connecting the components of the computer, a memory 606, a network interface 608, and I/O interfaces 610.

Processor 604 may include one processor or more than one interconnected processors. More specifically, processor 604 receives inputs from the event source 104 and user reaction source 106, and, using the databases 114-118, determines relationship(s) between a social media page and/or respective posts on a social media page, and one or more of the emotion categorizations. According to some embodiments, processor 604 may execute the processes 200, 300, 400 and 500.

The memory 606 may be configured to store databases 114, 116, 118 and 120. The memory may also be configured to efficiently store temporary associations between event records and emotion and/or emotion categories during execution of processes. In some embodiments tools and platforms that are tailored for “big data” may be used. For example, some embodiments use a distributed full-text search engine that allows searching in a scalable manner.

Network interface(s) 608 are utilized by processor 604 to access the social media content records and user responses to the social media content records. In some embodiments, the emotion tokens and/or the emotion categories databases are not local to the computer platform 600, and they too are accessed through the network interface(s).

I/O interface(s) 610 enables user of the provide configuration information and control information via one or more of a keyboard, touchscreen, voice to text translation etc. I/O interface 610 also enables delivery of the results of the processing performed by the processor to a screen or display.

Although the embodiment described above are primarily related to social media interactions and classifying according to emotions, embodiments are not limited thereto. Some embodiments of the present invention can also be described as follows. Consider a system that takes natural language texts (from here on out called “texts”) and classifies them “positive” or “negative”. The positive classified texts form a list of phrases that may be referred to as “positive indicators” that typically lead to a text being classified “positive” when those phrases are found within the text. A positive classification can only be caused by finding one of these positive indicators. The negative classified texts form a list of phrases referred to as “negative indicators” that are phrases in which a positive indicator is found but are exceptional because when these negative indicators are found they block the classifier from using the positive indicator within them to cause a positive classification. The presence of a negative indicator is said to cause a negative classification when it appears, since the negative indicator prevents the positive indicator inside it from causing the classification to be positive. If neither positive indicators nor negative indicators are found within a text, then the classifier classifies the text as negative.

Embodiments provide a cost-saving, time-saving, and expert-labor-saving algorithm to find new negative indicators for such a system, thereby improving the precision of positive classifications of the system. In conventional systems, finding new negative indicators usually required labor-intensive research by an expert to find phrases of sufficient length that the classifier should always classify texts containing that phrase negatively, but optimally short in length so that most texts possible are correctly classified negatively by the negative indicator.

Example embodiments work by creating simple questions to be asked to non-experts who (or systems that are not expert systems which) do not need to be educated on how the classification system works. The responses to the questions are used to find negative indicators that are sufficiently long but optimally short as described in the previous paragraph. Some example embodiments may utilize a historical source of natural language texts that provides examples of texts that can be analyzed by the non-experts and, as explained in the query step, provides context for knowing which such examples are useful at establishing representative usage patterns of candidate negative indicators.

The description set forth above in relation to FIGS. 1-5 with respect to events, user reaction records, emotion tokens and non-emotion tokens is applicable, in some embodiments, also to other applications in which, in response to various events, users may express reactions that can be classified as either a positive indicator or a negative indicator with respect to a particular criteria which may not be associated with an emotion.

In the examples described herein, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions. Although databases may be depicted herein as tables, other formats (including relational databases, object-based models, and/or distributed databases) may be used to store and manipulate data.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the technology, and does not imply that the illustrated process is preferred.

Processors, memory, network interfaces, I/O interfaces, and displays noted above are, or includes, hardware devices (for example, electronic circuits or combinations of circuits) that are configured to perform various different functions for a computing device, such as computer 600.

In some embodiments, each or any of the processors 604 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 604 uses an instruction set architecture such as x86 or Advanced RISC Machine (ARM).

In some embodiments, each or any of the memory devices 106 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 604). Memory devices 606 are examples of non-volatile computer-readable storage media.

In some embodiments, each or any of the network interface devices 108 includes one or more circuits (such as a baseband processor and/or a wired or wireless transceiver), and implements layer one, layer two, and/or higher layers for one or more wired communications technologies (such as Ethernet (IEEE 802.3) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces in IO interfaces 610 is or includes one or more circuits that receive data from the processors 104, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device, which displays the image data. Alternatively or additionally, in some embodiments, each or any of the display interfaces is or includes, for example, a video card, video adapter, or graphics processing unit (GPU).

In some embodiments, each or any of the user input adapters in I/O interfaces 110 is or includes one or more circuits that receive and process user input data from one or more user input devices that are included in, attached to, or otherwise in communication with the computing device 602, and that output data based on the received input data to the processors 604. Alternatively or additionally, in some embodiments each or any of the user input adapters is or includes, for example, a PS/2 interface, a USB interface, a touchscreen controller, or the like; and/or the user input adapters facilitates input from user input devices such as, for example, a keyboard, mouse, trackpad, touchscreen, etc.

Various forms of computer readable media/transmissions may be involved in carrying data (e.g., sequences of instructions) to a processor. For example, data may be (i) delivered from a memory to a processor; (ii) carried over any type of transmission medium (e.g., wire, wireless, optical, etc.); (iii) formatted and/or transmitted according to numerous formats, standards or protocols, such as Ethernet (or IEEE 802.3), ATP, Bluetooth, and TCP/IP, TDMA, CDMA, 3G, etc.; and/or (iv) encrypted to ensure privacy or prevent fraud in any of a variety of ways well known in the art.

It will be appreciated that as used herein, the terms system, subsystem, service, programmed logic circuitry, and the like may be implemented as any suitable combination of software, hardware, firmware, and/or the like. It also will be appreciated that the storage locations herein may be any suitable combination of disk drive devices, memory locations, solid state drives, CD-ROMs, DVDs, tape backups, storage area network (SAN) systems, and/or any other appropriate tangible computer readable storage medium. It also will be appreciated that the techniques described herein may be accomplished by having a processor execute instructions that may be tangibly stored on a computer readable storage medium.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

When it is described in this document that an action “may,” “can,” or “could” be performed, that a feature or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, component, attribute, etc. is present in at least one embodiment, though is not necessarily present in all embodiments.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A system for determining effectiveness of content posted on a social media network, comprising:
at least one memory;
at least one network communication interface; and
at least one processor configured to, in conjunction with the at least one memory and the at least one network communication interface, perform operations comprising:
receiving a set of social media content records posted to a network location and, for each social media content record in the set, one or more associated user reaction records posted in response to the social media content record;
assigning one or more emotion tokens to respective user reaction records based at least on an absence of any non-emotion tokens from a collection of non-emotion tokens in the respective user reaction records;
generating emotion engagement metrics for respective ones of the social media content records based on the emotion tokens assigned to the user reaction records associated with the respective social media content records;
outputting information associated with the generated emotion engagement metrics; and
taking as input respective ones of said user reaction records to which one or more emotion tokens are assigned, performing processing to determine non-emotion tokens and adding the determined non-emotion tokens to the collection of non-emotion tokens, wherein the processing to determine non-emotion tokens includes electronically obtaining evaluations from a crowdsourced evaluation platform for a plurality of pairs of a user reaction record and an emotion token assigned by said assigning to the user reaction record.

2. The system according to claim 1, wherein the processing to determine non-emotion tokens and the adding non-emotion tokens to the collection of non-emotion tokens is performed concurrently with the assigning.

3. The system according to claim 1, wherein the electronically obtaining evaluations from a crowdsourced evaluation platform includes electronically distributing each of the pairs to a plurality of workers of the crowdsourced evaluation platform.

4. The system according to claim 1, wherein the processing to determine non-emotion tokens includes, for each user reaction record taken as input:
generating one or more substrings of said user reaction record; and
electronically obtaining evaluations from the crowdsourced evaluation platform as to whether respective ones of the generated one or more substrings is correctly assigned with the one or more emotion tokens assigned to the corresponding user reaction record.

5. The system according to claim 4, wherein the at least one processor is further configured to perform said adding the determined non-emotion tokens to the collection of non-emotion tokens when all the generated one or more substrings are electronically evaluated as being incorrectly assigned.

6. The system according to claim 4, wherein the at least one processor is further configured to perform said adding the determined non-emotion tokens to the collection of non-emotion tokens only when all the generated one or more substrings are electronically evaluated as being incorrectly assigned.

7. The system according to claim 4, wherein the electronically obtaining evaluations from a crowdsourced evaluation platform as to whether respective ones of the generated one or more substrings is correctly assigned includes electronically distributing each generated substring to a plurality of workers of the crowdsourced evaluation platform to obtain a respective evaluation result.

8. The system according to claim 7, wherein the at least one processor is further configured to determine whether to add a particular one of the generated substrings to the collection of non-emotion tokens based on a plurality of evaluations results obtained from the crowdsourced evaluation platform.

9. The system according to claim 4, wherein the at least one processor is further configured to order the generated substrings from shortest to longest of said substrings; and wherein the electronically obtaining evaluations from the crowdsourced evaluation platform as to whether respective ones of the generated one or more substrings is correctly assigned comprises submitting the generated strings to the crowdsourced evaluation platform in a sequence arranged according to said ordering.

10. The system according to claim 4, wherein the generating one or more substrings of said user reaction record comprises generating each said one or more substrings so that it includes an emotion token.

11. The system according to claim 10, wherein the included emotion token is the same for all said one or more substrings.

12. The system according to claim 1, wherein the assigning one or more emotion tokens to respective user reaction records is further based on a presence of one or more emotion tokens in the respective user records.

13. A method comprises:
receiving as input, user reaction records to which one or more positive indicator tokens are assigned;
performing, using the received input, processing to determine negative indicator tokens; and
adding the determined negative indicator tokens to a collection of negative indicator tokens, wherein the collection is utilized by a computer process for assigning positive indicator tokens to user reaction records.

14. The method according to claim 13, wherein the processing to determine non-emotion tokens includes electronically obtaining evaluations from an evaluation platform for a plurality of pairs of a user reaction record and an emotion token assigned by said assigning to the user reaction record.

15. The method according to claim 14, wherein the evaluation platform is a crowdsourced evaluation platform.

16. The method according to claim 14, wherein the evaluation platform performs evaluation based on machine learning.

17. A non-transitory computer readable storage medium having stored thereon instructions, that when executed by at least one processor of a computer, cause the computer to perform operations comprising:
receiving as input, user reaction records to which one or more positive indicator tokens are assigned;
performing, using the received input, processing to determine negative indicator tokens; and
adding the determined negative indicator tokens to a collection of negative indicator tokens, wherein the collection is utilized by a computer process for assigning positive indicator tokens to user reaction records.
